(19) United States
(12) Patent Application Publication
(10) Pub. No.: US 2025/0048337 A1
(43) Pub. Date: Feb. 6, 2025

(54) SLOT STRUCTURE CONFIGURATION METHOD AND APPARATUS THEREOF

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/292,698

(22) PCT Filed: Jul. 28, 2021
(86) PCT No.: PCT/CN2021/109082

§ 371 Date: Feb. 7, 2024

(51) Int. Cl. H04W 72/044; H04L 5/00; H04W 72/02; H04W 72/542

(52) U.S. Cl. CPC H04W 72/044; H04L 5/006; H04W 72/02; H04W 72/542

(57) ABSTRACT

Disclosed in the embodiments of the present application are a slot structure configuration method and an apparatus thereof, which are applicable to a communication system. The method is executed by a terminal device, and includes, when a terminal device supports simultaneous uplink and downlink transmissions, sending, to a network device, a reference frequency interval, which is used for configuring uplink and downlink slot structures of the terminal device.

### CROSS REFERENCE TO RELATED APPLICATIONS

The present application is a national phase application of International Application No. PCT/CN2021/109082, filed on Jul. 28, 2021, and the entire contents thereof are incorporated herein by reference.

### BACKGROUND

### Technical Field

The present disclosure relates to the field of communication technology, and in particular, to a method for slot structure configuration and an apparatus thereof.

### Description of the Related Art

In related technologies, due to limitations of radio frequency hardware, when two frequency bands or two carriers are relatively close to each other, the uplink transmission information of one band will affect the downlink reception information of the other band, which reduces the transmission efficiency and spectrum usage efficiency to a certain extent.

It should be noted that, information disclosed in the above background portion is provided only for better understanding of the background of the present disclosure, and thus it may contain information that does not form the prior art known by those ordinary skilled in the art.

### SUMMARY

Embodiment of the present disclosure provides a method for slot structure configuration and an apparatus thereof.

In a first aspect, embodiments of the present application provide a method for slot structure configuration, which is executed by a terminal device. The method includes: when the terminal device supports simultaneous uplink and downlink transmission, sending to a network device a reference frequency interval for configuring uplink and downlink slot structure of the terminal device.

In one implementation, the method further includes: sending to the network device indication information indicating whether simultaneous uplink and downlink transmission is supported by the terminal device.

In one implementation, the sending to the network device the reference frequency interval for configuring uplink and downlink slot structure of the terminal device includes: sending a frequency type supported by the terminal device to the network device, wherein there is a mapping relationship between the frequency type and the reference frequency interval.

In a second aspect, the embodiments of the present disclosure provide another method for slot structure configuration, executed by a network device, and the method includes receiving a reference frequency interval for configuring uplink and downlink slot structure of a terminal device sent by the terminal device when simultaneous uplink and downlink transmission is supported by the terminal device, and configuring the uplink and downlink slot structure according to the reference frequency interval.

In one implementation, the method further includes according to the reference frequency interval, selecting for the terminal device a component carrier for carrier aggregation from candidate carriers, and configuring the uplink and downlink slot structure for the component carrier.

In one implementation, the according to the reference frequency interval, selecting for the terminal device the component carrier for carrier aggregation from candidate carriers, and configuring the uplink and downlink slot structure for the component carrier, includes: obtaining candidate frequency intervals between the candidate carriers and a main carrier; and in response to existence of target candidate carriers whose candidate frequency intervals are greater than the reference frequency interval among the candidate carriers, selecting component carriers from the target candidate carriers, and configuring different uplink and downlink slot structures for the component carriers; or in response to the target candidate carrier not existing among the candidate carriers, selecting the component carriers according to channel qualities of channels corresponding to the candidate carriers, and configuring a same uplink and downlink slot structure for the component carriers.

In one implementation, the method further includes: obtaining service traffic of the terminal device; and configuring the uplink and downlink slot structure for the terminal device according to the reference frequency interval and the service traffic.

In one implementation, the configuring the uplink and downlink slot structure for the terminal device according to the reference frequency interval and the service traffic includes: determining candidate frequency intervals between the candidate carriers of the terminal device and a main carrier; and in response to the service traffic being greater than a set threshold, selecting target candidate carriers whose candidate frequency intervals are greater than the reference frequency interval from the candidate carriers as component carriers, and configuring different uplink and downlink slot structures for the component carriers.

In one implementation, the method further includes: in response to the target candidate carrier not existing among the candidate carriers and/or the service traffic being less than the set threshold, selecting the component carriers according to channel qualities of channels corresponding to the candidate carriers, and configuring a same uplink and downlink slot structure for the component carriers.

In one implementation, the method further includes: receiving indication information sent by the terminal device for indicating whether simultaneous uplink and downlink transmission is supported by the terminal device.

In one implementation, the receiving the reference frequency interval for configuring uplink and downlink slot structure of the terminal device sent by the terminal device when simultaneous uplink and downlink transmission is supported by the terminal device, includes: receiving a frequency type supported by the terminal device sent by the terminal device; and querying a mapping relationship between the frequency type and the reference frequency interval, to obtain the frequency interval matching the frequency type supported by the terminal device as the reference frequency interval.

In a third aspect, embodiments of the present disclosure provide a communication apparatus that has some or all of the functions of the terminal device in implementing the method described in the first aspect. For example, the functions of the communication apparatus may have some or all of the functions in in the embodiments of this disclosure, or may have the functions for independently implementing any embodiment in the present disclosure. The functions described can be implemented by hardware, or can be implemented by hardware executing corresponding software. The hardware or software includes one or more units or modules corresponding to the above functions.

In one implementation, the structure of the communication apparatus may include a transceiver module and a processing module, and the processing module is configured to support the communication apparatus to perform corresponding functions in the above method. The transceiver module is used to support communication between the communication apparatus and other devices. The communication apparatus may further include a storage module coupled to the transceiver module and the processing module, which stores necessary computer programs and data for the communication apparatus.

As an example, the processing module may be a processor, the transceiver module may be a transceiver or a communication interface, and the storage module may be a memory.

In a fourth aspect, embodiments of the present disclosure provide another communication apparatus that has some or all of the functions of the network device in implementing the method example described in the second aspect. For example, the functions of the communication apparatus may have some or all of the functions in in the embodiments of this disclosure, or may have the functions for independently implementing any embodiment in the present disclosure. The functions described can be implemented by hardware, or can be implemented by hardware executing corresponding software. The hardware or software includes one or more units or modules corresponding to the above functions.

In one implementation, the structure of the communication apparatus may include a transceiver module and a processing module, and the processing module is configured to support the communication apparatus to perform corresponding functions in the above method. The transceiver module is used to support communication between the communication apparatus and other devices. The communication apparatus may further include a storage module coupled to the transceiver module and the processing module, which stores necessary computer programs and data for the communication apparatus.

As an example, the processing module may be a processor, the transceiver module may be a transceiver or a communication interface, and the storage module may be a memory.

A In a fifth aspect, an embodiment of the present disclosure provides a communication apparatus, which includes a processor, when the process invokes a computer program stored in a memory, the method according to the above first aspect is implemented.

In a sixth aspect, an embodiment of the present disclosure provides a communication apparatus, which includes a processor, when the process invokes a computer program stored in a memory, the method according to the above second aspect is implemented.

In a seventh aspect, an embodiment of the present disclosure provides a communication apparatus, which includes a processor and a memory, a computer program is stored in the memory, and the computer program stored in the memory is executed by the processor, to cause the device to implement the method according to the above first aspect.

In an eighth aspect, an embodiment of the present disclosure provides a communication apparatus, which includes a processor and a memory, a computer program is stored in the memory, and the computer program stored in the memory is executed by the processor, to cause the device to implement the method according to the above second aspect.

In a ninth aspect, an embodiment of the present disclosure provides a communication apparatus, which includes a processor and an interface circuit; the interface circuit is configured to receive code instructions and transmit the code instructions to the processor; and the processor is configured to execute the code instructions to implement the method according to the above first aspect.

In a tenth aspect, an embodiment of the present disclosure provides a communication apparatus, which includes a processor and an interface circuit; the interface circuit is configured to receive code instructions and transmit the code instructions to the processor; and the processor is configured to execute the code instructions to implement the method according to the above second aspect.

In an eleventh aspect, an embodiment of the present disclosure provides a system for slot structure configuration, which includes the communication apparatus described in the third aspect and the communication apparatus described in the fourth aspect, or the system includes the communication apparatus described in the fifth aspect and the communication apparatus described in the sixth aspect, or the system includes the communication apparatus described in the seventh aspect and the communication apparatus described in the eighth aspect, or the system includes the communication apparatus described in the ninth aspect and the communication apparatus described in the tenth aspect.

In a twelfth aspect, an embodiment of the present disclosure provides a computer-readable storage medium for storing instructions used by the above terminal device. When the instructions are executed, the method described in the first aspect is executed by the terminal device.

In a thirteenth aspect, an embodiment of the present disclosure provides a readable storage medium for storing instructions used by the above network device. When the instructions are executed, the method described in the second aspect is executed by the network device.

In a fourteenth aspect, the present disclosure also provides a computer program product including a computer program, which when been executed on a computer causes the computer to execute the method described in the first aspect.

In a fifteenth aspect, the present disclosure also provides a computer program product including a computer program, which when been executed on a computer causes the computer to execute the method described in the second aspect.

In a sixteenth aspect, the present disclosure provides a chip system. The chip system includes at least one processor and an interface for supporting the terminal device to implement the functions involved in the first aspect, for example, determining or processing at least one of the data and information involved in the above method. In a possible design, the chip system further includes a memory, and the memory is used to store necessary computer programs and data for the terminal device. The chip system may include chips, or may include chips and other discrete devices.

In a seventeenth aspect, the present disclosure provides a chip system. The chip system includes at least one processor and an interface for supporting the network device to implement the functions involved in the second aspect, for example, determining or processing at least one of the data and information involved in the above method. In a possible design, the chip system further includes a memory, and the memory is used to store necessary computer programs and data for the network device. The chip system may include chips, or may include chips and other discrete devices.

In an eighteenth aspect, the present disclosure provides a computer program that, when been executed on a computer, causes the computer to execute the method described in the above first aspect.

In a nineteenth aspect, the present disclosure provides a computer program that, when been executed on a computer, causes the computer to perform the method described in the above second aspect.

It is to be understood that both the foregoing general description and the following detailed description are exemplary and explanatory only and are not restrictive of the disclosure.

### BRIEF DESCRIPTION OF THE DRAWINGS

In order to more clearly explain the technical solutions in the embodiments of the present disclosure or the background technology, the drawings needed to be used in the embodiments or the background technology of the present disclosure will be described below.

FIG. 1 is a schematic architectural diagram of a communication system provided by an embodiment of the present disclosure;

FIG. 2 is a schematic flowchart of a method for slot structure configuration provided by an embodiment of the present disclosure;

FIG. 3 is a schematic flowchart of a method for slot structure configuration provided by an embodiment of the present disclosure;

FIG. 4 is a schematic flowchart of a method for slot structure configuration provided by an embodiment of the present disclosure;

FIG. 5 is a schematic flowchart of a method for slot structure configuration provided by an embodiment of the present disclosure;

FIG. 6 is a schematic flowchart of a method for slot structure configuration provided by an embodiment of the present disclosure;

FIG. 6 (a) is a schematic diagram of a slot structure provided by an embodiment of the present disclosure;

FIG. 6 (b) is a schematic diagram of a slot structure provided by an embodiment of the present disclosure;

FIG. 7 is a schematic flowchart of a method for slot structure configuration provided by an embodiment of the present disclosure;

FIG. 8 is a schematic structural diagram of a communication apparatus according to an embodiment of the present disclosure;

FIG. 9 is a schematic structural diagram of a communication apparatus according to an embodiment of the present disclosure; and

FIG. 10 is a schematic structural diagram of a chip according to an embodiment of the present disclosure.

### DETAILED DESCRIPTION OF THE PREFERRED EMBODIMENTS

To facilitate understanding, the terminology involved in this disclosure is first introduced.

### 1. Frequency Band (Band)

Frequency band, or bandwidth, refers to the width of frequency band occupied by a signal; when used to describe a channel, bandwidth refers to the maximum frequency bandwidth of a signal that can effectively pass through the channel. For analog signals, bandwidth is also called frequency width and is measured in Hertz (Hz).

Frequency band is a core concept in the fields of information theory, radio, communications, signal processing, and spectroscopy. For example, in radio communications, bandwidth is the range of frequencies occupied by a modulated carrier.

### 2. Time Slot

A time slot is the smallest unit for transmitting circuit switching summary information. A time slot can be understood as a channel. Multiple people share a resource and are processed using a time-division method. One time slot is equivalent to one channel.

In order to better understand the method for slot structure configuration disclosed in the embodiment of the present disclosure, the communication system to which the embodiment of the present disclosure is applicable is first described below.

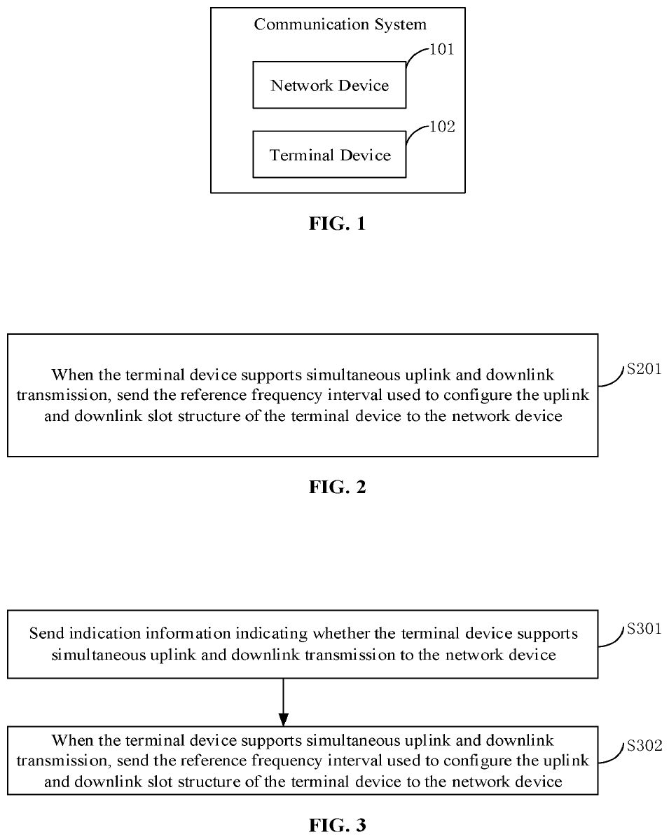

Please refer to FIG. 1, which is a schematic architectural diagram of a communication system provided by an embodiment of the present disclosure. The communication system may include but is not limited to a network device and a terminal device. The number and form of devices shown in FIG. 1 are only for examples and do not constitute a limitation on the embodiments of the present disclosure. In actual applications, it may include two or more network devices and two or more terminal devices. The communication system shown in FIG. 1 includes a network device 101 and a terminal device 102 for example.

It should be noted that the technical solutions of the embodiments of the present disclosure can be applied to various communication systems. For example: long term evolution (LTE) system, fifth generation (5G) mobile communication system, 5G new radio (NR) system, or other future new mobile communication systems. It should also be noted that the side link in the embodiment of the present disclosure may also be referred to as a sidelink or a direct link.

The network device 101 in the embodiment of the present disclosure is an entity on the network side that is used to transmit or receive signals. For example, the network device 101 may be an evolved base station (evolved NodeB, eNB), a transmission reception point (TRP), a next generation base station (next generation NodeB, gNB) in an NR system, or the base station in other future mobile communication systems or access point in a wireless fidelity (WiFi) system. The embodiments of the present disclosure do not limit the specific technologies and specific equipment forms used by the network device. The network device provided by the embodiments of the present disclosure may include a centralized unit (CU) and a distributed unit (DU). The CU may also be referred to as a control unit. Using the CU-DU structure can separate the protocol layers of network device, such as the base station, with some protocol layer functions placed under centralized control on the CU, while the remaining part or all protocol layer functions are distributed in the DU, and the DU is centrally controlled by the CU.

In the embodiment of the present disclosure, the terminal device 102 is an entity on the user side for receiving or transmitting signals, such as a mobile phone. The terminal device can also be referred to as terminal device (terminal), user equipment (user equipment, UE), mobile station (mobile station, MS), mobile terminal device (mobile terminal, MT), etc. The terminal device can be cars with communication functions, smart cars, mobile phones, wearable devices, tablets (Pads), computers with wireless transceiver functions, virtual reality (VR) terminal devices, augmented reality (AR) terminal device, wireless terminal device in industrial control, wireless terminal device in self-driving, wireless terminal device in remote medical surgery, wireless terminal device in smart grid, wireless terminal device in transportation safety, wireless terminal device in smart city, wireless terminal device in smart home, etc. The embodiments of the present disclosure do not limit the specific technology and specific equipment form used by the terminal device.

It can be understood that the communication system described in the embodiments of the present disclosure is to more clearly illustrate the technical solutions of the embodiments of the present disclosure, and does not constitute a limitation on the technical solutions provided by the embodiments of the present disclosure. As those of ordinary skill in the art will know, with the evolution of system architecture and the emergence of new service scenarios, the technical solutions provided by the embodiments of the present disclosure are also applicable to similar technical problems.

The method for slot structure configuration and apparatus thereof provided by the present disclosure will be introduced in detail below with reference to the accompanying drawings.

Please refer to FIG. 2. FIG. 2 is a schematic flowchart of a method for slot structure configuration provided by an embodiment of the present disclosure. As shown in FIG. 2, the method is executed by the terminal device and may include but is not limited to the following steps.

Step S201: When the terminal device supports simultaneous uplink and downlink transmission, send the reference frequency interval used to configure the uplink and downlink slot structure of the terminal device to the network device.

The terminal device transmits uplink information or data with network device through physical uplink channels, and transmits downlink information or data with network device through physical downlink channels. In order to support higher transmission frequencies, terminal device has introduced the ability to support simultaneous uplink and downlink transmission. That is to say, the terminal device can support uplink and downlink transmission at the same time.

In order to prevent the transmission of uplink information in one frequency band from affecting the reception of downlink information in another frequency band and improve spectrum efficiency, when the terminal device supports simultaneous uplink and downlink transmission, frequency interval information needs to be sent to the network device so that the network device can configure the uplink and downlink slot structures of the terminal device according to the received frequency interval information, so that the two frequency bands can transmit data/or information according to the configured uplink and downlink slot structures, and reduce the impact between the two frequency bands as much as possible.

The terminal device sends the reference frequency interval used to configure the uplink and downlink slot structure of the terminal device to the network device. In some implementations, the terminal device directly sends the reference frequency interval to the network device; in some implementations, the terminal device sends instruction information to the network device to instruct the network device to determine the reference frequency interval, and the network device can obtain the reference frequency interval according to the instruction information.

By implementing the embodiments of the present disclosure, spectrum efficiency and transmission efficiency can be improved and resource waste can be avoided. In this way, it can be avoided that when two bands or two carriers are close to each other, the uplink information transmission of one band affects the downlink information reception of the other band, thus ensuring the accuracy of uplink and downlink information transmission.

Please refer to FIG. 3. FIG. 3 is a schematic flowchart of a method for slot structure configuration provided by an embodiment of the present disclosure. As shown in FIG. 3, the method is executed by the network device and may include but is not limited to the following steps.

S301. Send indication information indicating whether the terminal device supports simultaneous uplink and downlink transmission to the network device.

In some implementations, in order to obtain whether the terminal device has the ability to support simultaneous uplink and downlink transmission, the terminal device sends indication information indicating whether the terminal device supports simultaneous uplink and downlink transmission to the network device. In this embodiment of the present disclosure, the indication information sent by the terminal device to indicate whether the terminal device supports simultaneous uplink and downlink transmission is 1 bit.

In response to the terminal device not having the capability to support uplink and downlink transmission simultaneously, the terminal device sends indication information to the network device indicating that the terminal device does not support simultaneous uplink and downlink transmission.

In response to the terminal device having the ability to support simultaneous uplink and downlink transmission, the terminal device sends indication information to the network device indicating that the terminal device supports simultaneous uplink and downlink transmission.

Optionally, in order to reduce the amount of calculation, the indication information indicating whether the terminal device supports simultaneous uplink and downlink transmission may not be sent. In some implementations, the terminal device does not send indication information indicating whether the terminal device supports simultaneous uplink and downlink transmission, and the default is that the terminal device does not have the ability to support simultaneous uplink and downlink transmission; in some implementations, the terminal device does not send indication information indicating whether the terminal device supports simultaneous uplink and downlink transmission, and the default is that the terminal device has the ability to support simultaneous uplink and downlink transmission.

S302: When the terminal device supports simultaneous uplink and downlink transmission, send the reference frequency interval used to configure the uplink and downlink slot structure of the terminal device to the network device.

The terminal device sends the reference frequency interval used to configure the uplink and downlink slot structure of the terminal device to the network device. In some implementations, the terminal device directly sends the reference frequency interval to the network device; in some implementations, the terminal device sends instruction information to the network device to instruct the network device to determine the reference frequency interval, and the network device can obtain the reference frequency interval according to the instruction information. In some implementations, the terminal device may send the frequency type supported by the terminal device to the network device, where the frequency type supported by the terminal device serves as indication information for instructing the network device to determine the reference frequency interval.

Optionally, there is a mapping relationship between the frequency type supported by the terminal device and the reference frequency interval according to pre-configuration or agreement, and different frequency types correspond to different reference frequency intervals. Correspondingly, the network device can obtain the reference frequency interval corresponding to the frequency type supported by the terminal device according to the mapping relationship.

For example, as shown in Table 1, for example, if the frequency type supported by the terminal device is Class 1, then the reference frequency interval corresponding to the frequency type is obtained according to the mapping relationship, which is 80 MHz; if the frequency type supported by the terminal device is Class 2, then according to the mapping relationship, the reference frequency interval corresponding to the frequency type obtained by the relationship is 60 MHz; the frequency type supported by the terminal device is Class 3, and the reference frequency interval corresponding to the frequency type obtained according to the mapping relationship is 40 MHz.

TABLE 1

| Frequency Type | Reference Frequency Interval |
|---|---|
| Class 1_{—} | 80 MHz_{—} |
| Class 2_{—} | 60 MHz_{—} |
| Class 3_{—} | 40 MHz_{—} |
| . . . | . . . |

It can be understood that each element and each corresponding relationship in Table 1 exists independently; these elements and corresponding relationships are exemplarily listed in the same table, but do not represent that all elements and corresponding relationships in the table must exist simultaneously as shown in Table 1. In the embodiment, the value of each element and each corresponding relationship are not dependent on any other element value or corresponding relationship in Table 1. Therefore, those skilled in the art can understand that the value of each element and each corresponding relationship in Table 1 are respectively an independent embodiment.

By implementing the embodiments of this disclosure, spectrum efficiency and transmission efficiency can be improved, resource waste can be avoided, and the accuracy of uplink and downlink information transmission can be ensured.

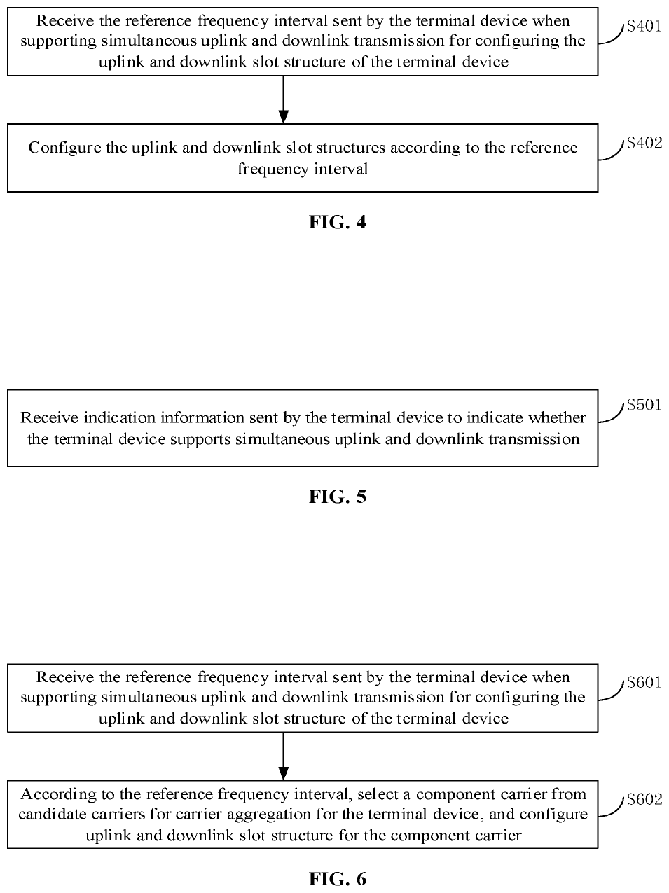

Please refer to FIG. 4. FIG. 4 is a schematic flowchart of a method for slot structure configuration provided by an embodiment of the present disclosure. As shown in FIG. 4, the method is executed by the network device and may include but is not limited to the following steps.

S401. Receive the reference frequency interval sent by the terminal device when supporting simultaneous uplink and downlink transmission for configuring the uplink and downlink slot structure of the terminal device.

In order to prevent the uplink information transmission in one frequency band from affecting the downlink information reception in another frequency band and improve spectrum efficiency, when the terminal device supports simultaneous uplink and downlink transmission, the network device receives the reference frequency interval sent by the terminal device so that the network device can configure the uplink and downlink slot structure of the terminal device according to the received frequency interval information.

In some implementations, the network device directly receives the reference frequency interval sent by the terminal device; in some implementations, the terminal device sends instruction information to the network device to instruct the network device to determine the reference frequency interval, and the network device obtains the reference frequency interval according to the instruction information.

In some implementations, the network device directly receives the reference frequency interval sent by the terminal device for configuring the uplink and downlink slot structure of the terminal device. In some implementations, the network device receives indication information sent by the terminal device to instruct the network device to determine the reference frequency interval, and the network device can obtain the reference frequency interval according to the indication information. In some implementations, the network device receives the frequency type supported by the terminal device sent by the terminal device, where the frequency type supported by the terminal device serves as indication information for instructing the network device to determine the reference frequency interval.

Optionally, there is a mapping relationship between the frequency type supported by the terminal device and the reference frequency interval according to pre-configuration or agreement, and different frequency types correspond to different reference frequency intervals. Correspondingly, the network device can obtain the reference frequency interval corresponding to the frequency type supported by the terminal device according to the mapping relationship.

For example, as shown in Table 1, for example, if the network device receives the frequency type supported by the terminal device sent by the terminal device is Class 1, then the reference frequency interval corresponding to the frequency type obtained according to the mapping relationship is 80 MHz; the network device receives the frequency type supported by the terminal device sent by the terminal device is Class 2, then the reference frequency interval corresponding to the frequency type obtained according to the mapping relationship is 60 MHz; the network device receives the frequency type supported by the terminal device sent by the terminal device is Class 3, then the reference frequency interval corresponding to the frequency type obtained according to the mapping relationship is 40 MHz.

S402: Configure the uplink and downlink slot structures according to the reference frequency interval.

In some implementations, the reference frequency interval is compared with the candidate frequency interval, and the uplink and downlink slot structures are configured based on the comparison results. Optionally, the candidate frequency interval may be a preset threshold, or may be the frequency interval between the candidate carrier and the main carrier.

Optionally, the service traffic of the terminal device will also affect the uplink and downlink transmission efficiency, thereby affecting the spectrum efficiency. Therefore, in some implementations, the uplink and downlink slot structure can also be configured according to the reference frequency interval and the current service traffic of the terminal device.

By implementing the embodiments of the present disclosure, spectrum efficiency and transmission efficiency can be improved and resource waste can be avoided. In this way, it can be avoided that when two bands or two carriers are close to each other, the uplink information transmission of one band affects the downlink information reception of the other band, thus ensuring the accuracy of uplink and downlink information transmission.

Please refer to FIG. 5. FIG. 5 is a schematic flowchart of a method for slot structure configuration provided by an embodiment of the present disclosure. As shown in FIG. 5, the method is executed by the network device and may include but is not limited to the following steps.

S501. Receive indication information sent by the terminal device to indicate whether the terminal device supports simultaneous uplink and downlink transmission.

In the embodiment of the present disclosure, in order to obtain whether the terminal device has the ability to support uplink and downlink transmission at the same time, the network device receives the indication information sent by the terminal device to indicate whether the terminal device supports simultaneous uplink and downlink transmission.

In response to the terminal device not having the ability to support simultaneous uplink and downlink transmission, the network device receives the indication information sent by the terminal device to indicate that the terminal device does not support simultaneous uplink and downlink transmission. At this time, the network device configures the carriers to operate at the same uplink and downlink slot structure.

In response to the terminal device having the ability to support simultaneous uplink and downlink transmission, the network device receives the instruction information sent by the terminal device to instruct that the terminal device supports simultaneous uplink and downlink transmission, and may also receive the reference frequency interval sent by the terminal device for configuring the uplink and downlink slot structure of the terminal device.

By implementing the embodiments of this disclosure, spectrum efficiency and transmission efficiency can be improved, resource waste can be avoided, and the accuracy of uplink and downlink information transmission can be ensured.

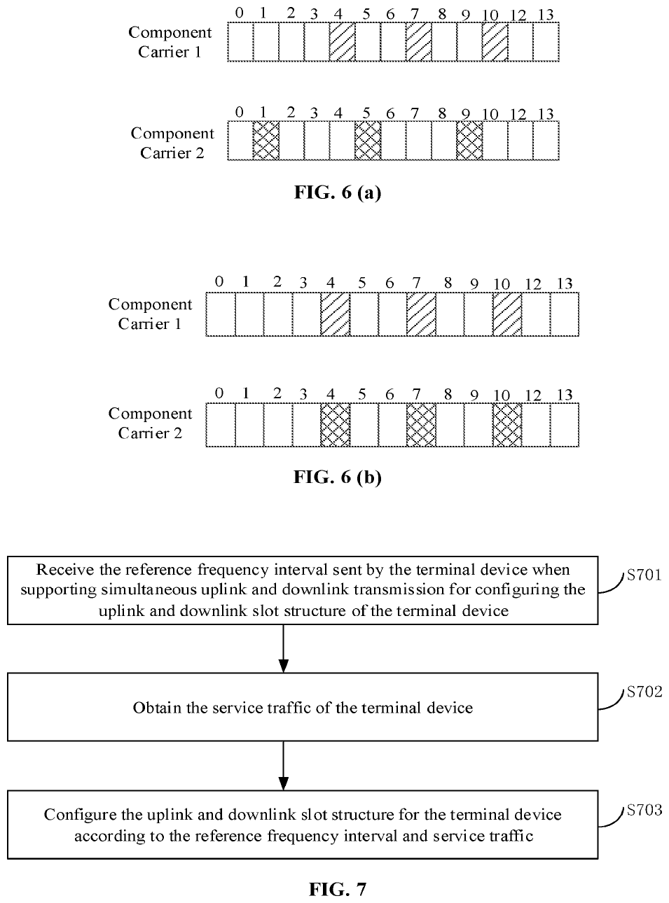

Please refer to FIG. 6, which is a schematic flowchart of a method for slot structure configuration provided by an embodiment of the present disclosure. As shown in FIG. 6, the method is executed by the network device and may include but is not limited to the following steps.

S601: Receive the reference frequency interval sent by the terminal device when supporting simultaneous uplink and downlink transmission for configuring the uplink and downlink slot structure of the terminal device. Regarding the content of step S601, please refer to the relevant introduction of the above embodiment, which will not be described again here.

S602: According to the reference frequency interval, select a component carrier from candidate carriers for carrier aggregation for the terminal device, and configure uplink and downlink slot structure for the component carrier. According to the reference frequency interval, multiple component carriers are selected from candidate carriers for the terminal device, and multiple continuous or non-continuous component carriers are carrier aggregated to aggregate into a larger band. Each component carrier has its own independent transmission channel, and the uplink and downlink slot structure is configured for the component carriers to determine the information type transmitted by the Orthogonal Frequency Division Multiplexing (OFDM) symbols in the slot class. In other words, the OFDM symbols used to transmit uplink information and the OFDM symbols used to transmit downlink information are configured.

Optionally, in response to the current system being an LTE system, a static uplink and downlink slot structure is configured for the component carrier, and in response to the current system being an NR system, a dynamic uplink and downlink slot structure is configured for the component carrier.

In some implementations, the frequency interval between the candidate carrier and the main carrier is obtained as the candidate frequency interval, and in response to the existence of target candidate carriers in the candidate carrier whose candidate frequency interval are greater than the reference frequency interval, i.e., the candidate frequency interval meets the usage requirements, in order to improve spectrum efficiency, component carriers are selected from the target candidate carriers, and different uplink and downlink slot structures are configured for the component carriers; as shown in FIG. 6 (a). For example, there are 14 OFDM symbols in a single slot, and for the component carriers 1, OFDM symbols with IDs 4, 7, and 10 are configured for transmission of uplink information, and the remaining OFDM symbols are configured for transmission of downlink information. For the component carrier 2, OFDM symbols with IDs 1, 5, and 9 are configured for transmission of uplink information, and the remaining OFDM symbols are configured for transmission of downlink information. At this time, the transmission of uplink information and the reception of downlink information may be carried out at the same time. Since the frequency band interval is large, the transmission of uplink information will not affect the reception of downlink information.

In some implementations, the frequency interval between the candidate carrier and the main carrier is obtained as the candidate frequency interval. In response to the target candidate carrier not existing in the candidate carrier, the uplink and downlink slot structures need to be constrained, that is, the component carrier is selected according to the channel quality of the channel corresponding to the candidate carriers, as shown in FIG. 6 (b). For example, candidate carriers can be sorted according to channel quality. Alternatively, candidate carriers corresponding to channel quality within a preset range can be selected as component carriers. Optionally, candidate carriers with better channel quality can be selected as the component carriers. Then the same uplink and downlink slot structure is configured for the component carrier. For example, for component carrier 1 and component carrier 2, the OFDM symbols with DIs 4, 7, 10 are configured for transmission of uplink information, and the remaining OFDM symbols are configured for transmission of downlink information. At this time, because the slot structure is the same and the frame structure is the same, uplink information can be transmitted or downlink information can be received at the same time. Therefore, the uplink information will not affect the reception of downlink information.

In the embodiment of the present disclosure, the terminal device selects component carriers from candidate carriers for carrier aggregation based on the reference frequency interval, and configures the uplink and downlink slot structures for the component carriers. The use of carrier aggregation (CA) can increase the transmission bandwidth, thereby increasing the transmission bit rate, improving spectrum efficiency, avoiding resource waste, and helping to ensure the accuracy of uplink and downlink information transmission.

The service traffic of the terminal device is also one of the factors that affects the transmission efficiency. When the service traffic is large, the transmission efficiency will be reduced. Therefore, in the configuration of the uplink and downlink slot structure in the embodiment of the present disclosure, the service traffic of the terminal device also needs to be considered. Please refer to FIG. 7, which is a schematic flowchart of a method for slot structure configuration provided by an embodiment of the present disclosure. As shown in FIG. 7, this method is executed by the network device and may include but is not limited to the following steps.

S701: Receive the reference frequency interval sent by the terminal device when supporting simultaneous uplink and downlink transmission for configuring the uplink and downlink slot structure of the terminal device. Regarding the content of step S701, please refer to the relevant introduction of the above embodiment, which will not be described again here.

S702: Obtain the service traffic of the terminal device. The service traffic refers to the data volume of all information transmitted in the communication system or communication network. When the service traffic is large, it may cause congestion of the transmission channel, and in serious cases, it may cause system failure. Therefore, the embodiment of this disclosure also needs to configure the plink and downlink slot structure with reference to the service traffic of the terminal device.

S703: Configure the uplink and downlink slot structure for the terminal device according to the reference frequency interval and service traffic. The candidate frequency interval between the candidate carrier and the main carrier of the terminal device is determined. In some implementations, in response to the service traffic being greater than the set threshold, that is, the terminal device needs to transmit a large service traffic. In order to improve the transmission efficiency, it is necessary to select target candidate carriers whose candidate frequency intervals are greater than the reference frequency interval from the candidate carriers as the component carriers, and configure different uplink and downlink slot structures for the component carriers.

In some implementations, in response to the target candidate carrier not existing among the candidate carriers, that is, the candidate frequency interval is not greater than the reference frequency interval, the component carriers are selected according to the channel qualities of the channels corresponding to the candidate carriers. For example, the candidate carrier can be selected according to the channel quality. Carriers are sorted, and optionally, candidate carriers corresponding to channel quality within a preset range can be selected as the component carriers. Optionally, candidate carriers with better channel quality can also be selected as the component carriers.

In some implementations, in response to the service traffic being less than the set threshold, that is, the amount of data that the terminal device needs to transmit is small, component carriers are selected according to the channel qualities of the channels corresponding to the candidate carriers, and the same uplink and downlink slot structure is configured for the component carriers.

In some implementations, in response to the fact that there is no target candidate carrier among the candidate carriers and the service traffic is less than a set threshold, the component carriers are selected according to the channel qualities of the channels corresponding to the candidate carriers, and the same uplink and downlink slot structure is configured for the component carriers.

In the embodiment of the present disclosure, the terminal device selects component carriers from candidate carriers for carrier aggregation based on the reference frequency interval, and configures the uplink and downlink slot structures for the component carriers.

The use of carrier aggregation (CA) can increase the transmission bandwidth, thereby increasing the transmission bit rate, improving spectrum efficiency, avoiding resource waste, and helping to ensure the accuracy of uplink and downlink information transmission.

In the above embodiments provided by the present disclosure, the methods provided by the embodiments of the present disclosure are introduced from the perspectives of network device and first terminal device respectively. In order to implement each function in the method provided by the above embodiments of the present disclosure, the network device and the first terminal device may include a hardware structure and a software module to implement the above functions in the form of a hardware structure, a software module, or combination of a hardware structure and a software module. A certain function among the above functions can be executed by a hardware structure, a software module, or combination of a hardware structure and a software module.

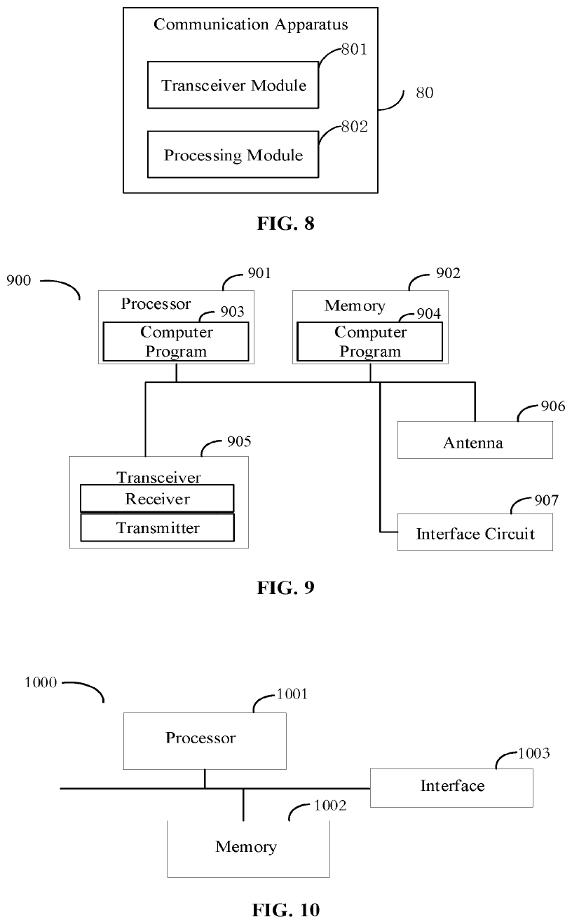

Please refer to FIG. 8, which is a schematic structural diagram of a communication apparatus 80 provided by an embodiment of the present disclosure. The communication apparatus 80 shown in FIG. 8 may include a transceiver module 801 and a processing module 802. The transceiver module 801 may include a sending module and/or a receiving module. The sending module is used to implement the sending function, and the receiving module is used to implement the receiving function. The transceiver module 801 may implement the sending function and/or the receiving function.

The communication apparatus 80 may be a terminal device (such as the first terminal device in the foregoing method embodiment), an apparatus in the terminal device, or an apparatus that can be used in conjunction with the terminal device. Alternatively, the communication apparatus 80 may be a network device, an apparatus in a network device, or an apparatus that can be used in conjunction with the network device.

The communication apparatus 80 is a terminal device (such as the first terminal device in the aforementioned method embodiment), including:

a transceiver module 801, configured to send the reference frequency interval used to configure the uplink and downlink slot structure of the terminal device to the network device when the terminal device supports simultaneous uplink and downlink transmission.

The transceiver module 801 is also configured to send indication information indicating whether the terminal device supports simultaneous uplink and downlink transmission to the network device.

The transceiver module 801 is also configured to: send the frequency type supported by the terminal device to the network device, where there is a mapping relationship between the frequency type and the reference frequency interval.

By implementing the embodiments of the present disclosure, spectrum efficiency and transmission efficiency can be improved and resource waste can be avoided. In this way, it can be avoided that when two bands or two carriers are close to each other, the uplink information transmission of one band affects the downlink information reception of the other band, thus ensuring the accuracy of uplink and downlink information transmission.

The communication apparatus 80 is a network device, including:
a transceiver module 801, configured to receive the reference frequency interval sent by the terminal device when supporting simultaneous uplink and downlink transmission for configuring the uplink and downlink slot structure of the terminal device; and
a processing module 802, configured to configure the uplink and downlink slot structure according to the reference frequency interval.

The processing module 802 is also configured to: select component carriers from candidate carriers for carrier aggregation for the terminal device according to the reference frequency interval, and configure the uplink and downlink slot structures for the component carriers.

The processing module 802 is also configured to: obtain the candidate frequency interval between the candidate carrier and the main carrier; in response to the existence of a target candidate carrier whose candidate frequency interval is greater than the reference frequency interval among the candidate carriers, select component carriers from the target candidate carriers, and configure the component carriers with different uplink and downlink slot structures; or, in response to the target candidate carrier not existing among the candidate carriers, select component carriers according to the channel qualities of the channels corresponding to the candidate carriers, and configure the same uplink and downlink slot structure for the component carriers.

The processing module 802 is also configured to: obtain the service traffic of the terminal device; and configure the uplink and downlink slot structure for the terminal device according to the reference frequency interval and service traffic.

The processing module 802 is also configured to: determine the candidate frequency interval between the candidate carrier and the main carrier of the terminal device; in response to the service traffic being greater than the set threshold, select the target candidate carriers whose candidate frequency intervals are greater than the reference frequency interval from the candidate carriers as the component carriers, and configure different uplink and downlink slot structures for the component carriers.

The processing module 802 is also configured to: in response to the target candidate carrier not existing among the candidate carriers and/or the service traffic being less than the set threshold, select component carriers according to the channel qualities of the channels corresponding to the candidate carriers, and configure the same uplink and downlink slot structure for the component carriers.

The transceiver module 801 is also configured to receive indication information sent by the terminal device to indicate whether the terminal device supports simultaneous uplink and downlink transmission.

The transceiver module 801 is also configured to: receive the frequency type supported by the terminal device sent by the terminal device; query the mapping relationship between the frequency type and the frequency interval, and obtain the frequency interval that matches the frequency type supported by the terminal device as the reference frequency interval.

By implementing the embodiments of the present disclosure, spectrum efficiency and transmission efficiency can be improved and resource waste can be avoided. In this way, it can be avoided that when two bands or two carriers are close to each other, the uplink information transmission of one band affects the downlink information reception of the other band, thus ensuring the accuracy of uplink and downlink information transmission.

Please refer to FIG. 9, which is a schematic structural diagram of another communication apparatus 90 provided by an embodiment of the present disclosure. The communication apparatus 90 may be a network device, or may be a terminal device (e.g., the first terminal device in the above method embodiment), or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication apparatus 90 may include one or more processors 901. The processor 901 may be a general-purpose processor or a dedicated processor, or the like. For example, the processor 901 may be a baseband processor or a central processing unit. The baseband processor can be used to process communication protocols and communication data. The central processor can be used to control the communication apparatus (such as base stations, baseband chips, terminal devices, terminal device chips, DU or CU, or the like), execute computer programs, and process data for the computer programs.

Optionally, the communication apparatus 90 may also include one or more memories 902, on which a computer program 904 may be stored. The processor 901 executes the computer program 904, so that the communication apparatus 90 performs the method described in the above method embodiments. Optionally, the memory 902 may also store data. The communication apparatus 90 and the memory 902 can be provided separately or integrated together.

Optionally, the communication apparatus 90 may also include a transceiver 905 and an antenna 906. The transceiver 905 may be referred to as a transceiver unit, a transceiver, a transceiver circuit, or the like, and is used to implement transceiver functions. The transceiver 905 may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

Optionally, the communication apparatus 90 may also include one or more interface circuits 907. The interface circuit 907 is used to receive code instructions and transmit the code instructions to the processor 901. The processor 901 executes the code instructions to cause the communication apparatus 90 to perform the method described in the above method embodiments.

The communication apparatus 90 is a terminal device (e.g., the first terminal device in the above method embodiments): the transceiver 905 is used to perform step S201 in FIG. 2; and steps S301 and S302 in FIG. 3.

The communication apparatus 90 is a network device: the transceiver 905 is used to perform step S401 in FIG. 4; step S501 in FIG. 5; step S601 in FIG. 6; and step S701 in FIG. 7. The processor 901 is used to execute step S402 in FIG. 4, and steps S702 and S703in FIG. 7.

In one implementation, the processor 901 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In one implementation, the processor 901 may be stored with a computer program 903, and the computer program 903 is executed by the processor 901, causing the communication apparatus 90 to perform the method described in the above method embodiments. The computer program 903 may be solidified in the processor 901, in which case the processor 901 may be implemented by hardware.

In one implementation, the communication apparatus 90 may include a circuit, and the circuit may implement the functions of sending or receiving or communicating in the foregoing method embodiments. The processors and transceivers described in this disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication apparatus described in the above embodiments may be a network device or a terminal device (e.g., the first terminal device in the above method embodiments), but the scope of the communication apparatus described in this disclosure is not limited thereto, and the structure of the communication apparatus may not be limited by FIG. 9. The communication apparatus may be a stand-alone device or may be part of a larger device. For example, the communication apparatus may be:
(1) a stand-alone integrated circuit IC, or chip, or chip system or subsystem;
(2) a set of one or more ICs. Optionally, the IC set may also include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

For the case where the communication apparatus may be a chip or a chip system, reference may be made to the schematic structural diagram of the chip shown in FIG. 10. The chip shown in FIG. 10 includes a processor 1001 and an interface 1003. The processor 1001 may include one or more processors, and the interface 1003 may include multiple interfaces.

For the case where the chip is used to implement the functions of the terminal device (e.g., the first terminal device in the above method embodiments) in the embodiment of the present disclosure:

The interface 1003 is configured to execute the step S201 in FIG. 2.

For the case where the chip is used to implement the functions of the network device in the embodiment of the present disclosure:

The interface 1003 is configured to execute the step S401 in FIG. 4; step S501 in FIG. 5; step S601 in FIG. 6; and step S701 in FIG. 7.

Optionally, the chip also includes a memory 1002, which is used to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure also provide a system for slot structure configuration. The system includes a communication apparatus as a terminal device (e.g., the first terminal device in the above method embodiments) and a communication apparatus as a network device in the embodiment of FIG. 9, or the system includes a communication apparatus as an access network device and a communication apparatus as a core network device in the embodiment of FIG. 10.

The present disclosure also provides a computer-readable storage medium on which instructions are stored. When the instructions are executed by a computer, the functions of any of the above method embodiments are implemented.

The present disclosure also provides a computer program product, which, when been executed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in this disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The corresponding relationships shown in each table in this disclosure can be configured or predefined. The values of the information in each table are only examples and can be configured as other values, which is not limited by this disclosure. When configuring the correspondence between information and each parameter, it is not necessarily required to configure all the correspondences shown in each table. For example, in the table in this disclosure, the corresponding relationships shown in some rows may not be configured. For another example, appropriate deformation adjustments can be made based on the above table, such as splitting, merging, or the like. The names of the parameters shown in the titles of the above tables may also be other names understandable by the communication apparatus, and the values or expressions of the parameters may also be other values or expressions understandable by the communication apparatus. When implementing the above tables, other data structures can also be used, such as arrays, queues, containers, stacks, linear lists, pointers, linked lists, trees, graphs, structures, classes, heaps, hash tables, or the like.

Predefinition in this disclosure may be understood as definition, pre-definition, storage, pre-storage, pre-negotiation, pre-configuration, firming, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are implemented in hardware or software depends on the specific application and design restrictions of the technical solution. Those skilled in the art may implement the described functions using different methods for each specific application, but such implementations should not be considered to be beyond the scope of this disclosure.

Those skilled in the art can clearly understand that for the convenience and simplicity of description, the specific operating processes of the systems, devices and units described above can be referred to the corresponding processes in the foregoing method embodiments, which will not be described again here.

The above are only specific embodiments of the present disclosure, but the protection scope of the present disclosure is not limited thereto. Any changes or substitutions easily conceivable to those skilled in the art within the technical scope disclosed in the present disclosure should be covered by the protection scope of this disclosure. Therefore, the protection scope of the present disclosure should be subject to the protection scope of the claims.

1. A method for slot structure configuration, executed by a terminal device, and the method comprising:
when simultaneous uplink and downlink transmission is supported by the terminal device, sending to a network device a reference frequency interval for configuring uplink and downlink slot structure of the terminal device.

2. The method according to claim 1, further comprising:
sending to the network device indication information indicating whether simultaneous uplink and downlink transmission is supported by the terminal device.

3. The method according to claim 1, wherein the sending to the network device the reference frequency interval for configuring uplink and downlink slot structure of the terminal device comprises:
sending a frequency type supported by the terminal device to the network device, wherein there is a mapping relationship between the frequency type and the reference frequency interval.

4. A method for slot structure configuration, executed by a network device, and the method comprising:
receiving a reference frequency interval for configuring uplink and downlink slot structure of a terminal device sent by the terminal device when simultaneous uplink and downlink transmission is supported by the terminal device; and
configuring the uplink and downlink slot structure according to the reference frequency interval.

5. The method according to claim 4, further comprising:
according to the reference frequency interval, selecting for the terminal device a component carrier for carrier aggregation from candidate carriers, and configuring the uplink and downlink slot structure for the component carrier.

6. The method according to claim 5, wherein the according to the reference frequency interval, selecting for the terminal device the component carrier for carrier aggregation from candidate carriers, and configuring the uplink and downlink slot structure for the component carrier, comprises:
obtaining candidate frequency intervals between the candidate carriers and a main carrier; and
in response to existence of target candidate carriers whose candidate frequency intervals are greater than the reference frequency interval among the candidate carriers, selecting component carriers from the target candidate carriers, and configuring different uplink and downlink slot structures for the component carriers; or
in response to the target candidate carrier not existing among the candidate carriers, selecting the component carriers according to channel qualities of channels corresponding to the candidate carriers, and configuring a same uplink and downlink slot structure for the component carriers.

7. The method according to claim 4, further comprising:
obtaining service traffic of the terminal device; and
configuring the uplink and downlink slot structure for the terminal device according to the reference frequency interval and the service traffic.

8. The method according to claim 7, wherein configuring the uplink and downlink slot structure for the terminal device according to the reference frequency interval and the service traffic comprises:
determining candidate frequency intervals between the candidate carriers of the terminal device and a main carrier; and
in response to the service traffic being greater than a set threshold, selecting target candidate carriers whose candidate frequency intervals are greater than the reference frequency interval from the candidate carriers as component carriers, and configuring different uplink and downlink slot structures for the component carriers.

9. The method according to claim 78, further comprising:
in response to the target candidate carrier not existing among the candidate carriers and/or the service traffic being less than the set threshold, selecting the component carriers according to channel qualities of channels corresponding to the candidate carriers, and configuring a same uplink and downlink slot structure for the component carriers.

10. The method according to claim 4, further comprising:
receiving indication information sent by the terminal device for indicating whether simultaneous uplink and downlink transmission is supported by the terminal device.

11. The method according to claim 4, wherein the receiving the reference frequency interval for configuring uplink and downlink slot structure of the terminal device sent by the terminal device when simultaneous uplink and downlink transmission is supported by the terminal device, comprises:
receiving a frequency type supported by the terminal device sent by the terminal device; and
querying a mapping relationship between the frequency type and the reference frequency interval, to obtain the frequency interval matching the frequency type supported by the terminal device as the reference frequency interval.

12. A communication apparatus comprising a processor and a memory, wherein a computer program is stored in the memory, and the processor is configured to execute the computer program stored in the memory, to cause the apparatus to execute the method according to claim 1.

13-14. (canceled)

15. A communication apparatus comprising a processor and a memory, wherein a computer program is stored in the memory, and the processor is configured to execute the computer program stored in the memory, to cause the apparatus to:
receive a reference frequency interval for configuring uplink and downlink slot structure of a terminal device sent by the terminal device when simultaneous uplink and downlink transmission is supported by the terminal device; and
configure the uplink and downlink slot structure according to the reference frequency interval.

16. The communication apparatus according to claim 15, wherein the processor is further configured to:
according to the reference frequency interval, select for the terminal device a component carrier for carrier aggregation from candidate carriers, and configure the uplink and downlink slot structure for the component carrier.

17. The communication apparatus according to claim 16, wherein the processor is further configured to:
obtain candidate frequency intervals between the candidate carriers and a main carrier; and
in response to existence of target candidate carriers whose candidate frequency intervals are greater than the reference frequency interval among the candidate carriers, select component carriers from the target candidate carriers, and configure different uplink and downlink slot structures for the component carriers; or
in response to the target candidate carrier not existing among the candidate carriers, select the component carriers according to channel qualities of channels corresponding to the candidate carriers, and configure a same uplink and downlink slot structure for the component carriers.

18. The communication apparatus according to claim 15, the processor is further configured to:
obtain service traffic of the terminal device; and
configure the uplink and downlink slot structure for the terminal device according to the reference frequency interval and the service traffic.

19. The communication apparatus according to claim 18, wherein the processor is further configured to:
determine candidate frequency intervals between the candidate carriers of the terminal device and a main carrier; and
in response to the service traffic being greater than a set threshold, select target candidate carriers whose candidate frequency intervals are greater than the reference frequency interval from the candidate carriers as component carriers, and configure different uplink and downlink slot structures for the component carriers.

20. The communication apparatus according to claim 1819, wherein the processor is further configured to:
in response to the target candidate carrier not existing among the candidate carriers and/or the service traffic being less than the set threshold, select the component carriers according to channel qualities of channels corresponding to the candidate carriers, and configure a same uplink and downlink slot structure for the component carriers.

21. The communication apparatus according to claim 15, wherein the apparatus is further caused to:
receive indication information sent by the terminal device for indicating whether simultaneous uplink and downlink transmission is supported by the terminal device.

22. The communication apparatus according to claim 15, wherein the apparatus is further caused to:
receive a frequency type supported by the terminal device sent by the terminal device; and
query a mapping relationship between the frequency type and the reference frequency interval, to obtain the frequency interval matching the frequency type supported by the terminal device as the reference frequency interval.

23-28. (canceled)
